(19) United States
(12) Patent Application Publication
(10) Pub. No.: US 2013/0287885 A1
(43) Pub. Date: Oct. 31, 2013

(54) TWO-PLATEN HYBRID INJECTION MOLDING MACHINE

(71) Applicant: Athena Automation Ltd., (US)

(72) Inventor: Robert D. Schad, Toronto (CA)

(21) Appl. No.: 13/872,803

(22) Filed: Apr. 29, 2013

Related U.S. Application Data
(60) Provisional application No. 61/639,307, filed on Apr. 27, 2012.

(51) Int. Cl. B29C 45/40

(52) U.S. Cl. CPC B29C 45/40
USPC 425/556; 425/542

(57) ABSTRACT

An injection molding machine comprises a machine base, and a stationary platen and a moving platen supported by the base. Each platen supports a respective stationary and moving mold half for forming a mold between the platens. An electrically driven platen actuator is coupled to the moving platen for advancing and retracting the moving platen between mold-closed and mold-open positions. At least one hydraulic clamp actuator is coupled to the platens for clamping together the stationary and moving platens when the moving platen is in the mold-closed position. A hydraulically powered rotary injection drive is coupled to the plasticizing screw for rotating the screw, and a hydraulic injection actuator is coupled to a plasticizing screw for injecting the injection material into the mold.

This application claims the benefit of U.S. Provisional Patent Application Ser. No. 61/639,307 filed on Apr. 27, 2012, the entire contents of which are hereby incorporated by reference herein.

### FIELD

The disclosure relates to injection molding machines, and to components and layout for a two-platen hybrid injection molding machine.

### BACKGROUND

U.S. Pat. No. 7,449,139 (Kestle) purports to disclose a molding-system platen actuator. The molding-system platen actuator includes a platen-stroke actuator. The platen-stroke actuator includes an electrical actuator, and a guide bushing connected with the electrical actuator. The molding-system platen actuator further includes a mold-break actuator in-line with the platen-stroke actuator. The mold-break actuator includes: a hydraulic actuator having a piston that is strokable along an in-line housing, and air pressure that is generatable between the piston and the guide bushing. The air pressure is useable to push the piston backwardly.

U.S. Pat. No. 6,322,343 (Yoda et al.) purports to disclose a compact injection molding machine with casters. An injection unit and a mold clamping unit in the compact injection molding machine are disposed longitudinally on a base cabinet which is formed of a tall cabinet with a rectangular top surface. The molding machine can be manually moved and installed by mounting the casters on the bottom of the base cabinet. The inside of the base cabinet is partitioned with partition plates and receives units and devices required for the injection molding of resin. The injection unit and mold clamping unit may use any of oil pressure and electric power as their driving source. In the case of oil pressure, a hydraulic driving circuit and the like are received in the base cabinet, and in the case of electric power, electric servomotors and the like are received in the base cabinet. Further, the operation side of the top surface of base cabinet can be formed into a work table, by disposing the injection unit and mold clamping unit longitudinally offset toward the counter-operation side on the top surface of base cabinet.

U.S. Pat. No. 5,756,019 (Nakazawa et al.) purports to disclose an injection pressure is detected as a pressure detection value Dp during injection and filling, and the thus obtained pressure detection value Dp is multiplied by a preset predetermined coefficient so as to be converted into a desired mold clamping force Fc with which the mold clamping force is controlled. The desired mold clamping force Fc is set to a minimum value which a mold does not open, that is, the desired mold clamping force Fc is calculated with the use of Fc=(α*S*β)Dp, where α is a charging rate of resin in a mold cavity, S is an entire projected area of a molding article, β is a safety factor, and Dp is a pressure detection value Dp. With this arrangement, in a section where the injection pressure gradually increases from zero during injection and filling, the profile (variation curve) of mold clamping force gradually increases as the injection pressure varies. At this stage, the mold clamping force during injection and filling is set to a minimum value with which the mold does not open so that the power consumption can be minimized.

### SUMMARY

The following summary is intended to introduce the reader to various aspects of the applicant's teaching, but not to define any invention. In general, disclosed herein are one or more methods or apparatuses related to injection molding.

According to some aspects of the teaching disclosed herein, an injection molding machine comprises a machine base, and a stationary platen and a moving platen supported by the base. Each platen supports a respective stationary and moving mold half for forming a mold between the platens. An electrically driven platen actuator is coupled to the moving platen for advancing and retracting the moving platen between mold-closed and mold-open positions. At least one hydraulic clamp actuator is coupled to the platens for clamping together the stationary and moving platens when the moving platen is in the mold-closed position. An injection unit is supported by the base and includes a plasticizing screw for plasticizing an injection material. A hydraulically powered rotary injection drive is coupled to the plasticizing screw for rotating the screw, and a hydraulic injection actuator is coupled to the plasticizing screw for injecting the injection material into the mold. An ejector is coupled to the moving platen. An electrically driven ejector actuator is coupled to the ejector for moving the ejector between advanced and retracted positions for ejecting molded articles from the moving mold half when the moving platen is in the mold-open position.

The injection molding machine may further comprise a plurality of tie bars generally extending between the stationary and moving platens. Each of the at least one hydraulic clamp actuators may comprise a piston affixed to a respective tie bar and slidable within a respective cylinder housing. Each cylinder housing may provide a clamp chamber and an unclamp chamber on opposite sides of the respective piston.

The platen actuator may comprise a first ball screw driven by a first motor. The ejector actuator may comprise a second ball screw driven by a second motor.

The base may comprise an injection unit support portion beneath the injection unit and a platen support portion beneath the platens. The injection unit support portion of the base may house an electrical cabinet, a pump cabinet, and a hydraulic tank disposed laterally intermediate the pump cabinet and the electrical cabinet.

The injection unit support portion may be generally bounded laterally by an axially extending front wall and an axially extending back wall. The injection support portion may be generally bounded axially by a laterally extending inner wall adjacent the platen support portion, and a laterally extending outer wall spaced apart from the inner wall. The tank may have a tank length that extends from laterally extending inner and outer tank walls that are axially intermediate the inner and outer walls of the injection unit support portion.

The tank may have a tank width that extends laterally between a first sidewall and a second sidewall. The first sidewall may be generally parallel to, and laterally intermediate, the front and back walls of the injection unit support portion of the base and run axially between the inner and outer lateral walls. The second sidewall may generally be parallel to the first sidewall, and laterally intermediate the first sidewall and the back wall of the injection unit support portion.

The electrical cabinet may be disposed in the injection unit support portion of the base, generally between the front wall and the first sidewall. The pump cabinet may be disposed in the injection unit support portion of the base, generally between the second sidewall and the back wall.

The base may have a base width extending laterally between the front and back walls. The base width may be between about 3 times and about 10 times greater than the tank width. The tank length may be between about 2 times and about 10 times greater than the tank width.

According to other aspects of the teaching disclosed herein, an injection molding machine comprises a base extending lengthwise along a machine axis. The base has a platen support portion extending along a first axial portion of the base, and an injection unit support portion extending along a second axial portion of the base. A pair of platens may be supported by the platen support portion of the base for carrying respective mold halves of a mold. An injection unit may be supported by the injection unit support portion of the base for injecting melt into the mold. The injection unit support portion of the base houses an electrical cabinet, a pump cabinet, and a hydraulic tank disposed laterally intermediate the pump cabinet and the electrical cabinet.

The injection unit support portion may be generally bounded laterally by an axially extending front wall and an axially extending back wall. The injection support portion may be generally bounded axially by a laterally extending inner wall adjacent the platen support portion, and a laterally extending outer wall spaced apart from the inner wall. The tank may have a tank length that extends from laterally extending inner and outer tank walls that are axially intermediate the inner and outer walls of the injection unit support portion.

The tank may have a tank width that extends laterally between a first sidewall and a second sidewall. The first sidewall may be generally parallel to, and laterally intermediate, the front and back walls of the injection unit support portion of the base. The second sidewall may be generally parallel to the first sidewall, and laterally intermediate the first sidewall and the back wall of the injection unit support portion.

The pump cabinet may be disposed in the injection unit support portion of the base, generally between the front wall and the first sidewall. The electrical cabinet may be disposed in the injection unit support portion of the base, generally between the second sidewall and the back wall.

The electrical cabinet may be disposed in the injection unit support portion of the base, generally between the front wall and the first sidewall. The pump cabinet may be disposed in the injection unit support portion of the base, generally between the second sidewall and the back wall.

The base may have a base width extending laterally between the front and back walls, and the base width may be between about 3 times and about 10 times greater than the tank width. The tank length may be between about 2 times and about 10 times greater than the tank width.

One of the platens may be a moving platen, and the machine may further comprise an electrically driven platen actuator coupled to the moving platen for advancing and retracting the moving platen between mold-closed and mold-open positions. The platen actuator may comprise a first ball screw driven by a first motor.

The machine may further comprise at least one hydraulic clamp actuator coupled to the platens for clamping together the platens when the platens are in a mold-closed position. The injection molding machine may further comprise a plurality of tie bars generally extending between the platens. Each of the at least one hydraulic clamp actuators may comprise a piston affixed to a respective tie bar and slidable within a respective cylinder housing. Each cylinder housing provides a clamp chamber and an unclamp chamber on opposite sides of the respective piston.

The machine may further comprise an injection unit supported by the base. The injection unit may include a plasticizing screw for plasticizing an injection material. A hydraulically powered rotary injection drive may be coupled to the plasticizing screw for rotating the screw. A hydraulic injection actuator may be coupled to the plasticizing screw for injecting the injection material into the mold.

The machine may further comprise an ejector coupled to the moving platen. An electrically driven ejector actuator may be coupled to the ejector for moving the ejector between advanced and retracted positions for ejecting molded articles from one of the mold halves when the platens are in the mold-open position. The ejector actuator may comprise a second ball screw driven by a second motor.

Other aspects and features of the present specification will become apparent, to those ordinarily skilled in the art, upon review of the following description of the specific examples of the specification.

### BRIEF DESCRIPTION OF THE DRAWINGS

The drawings included herewith are for illustrating various examples of articles, methods, and apparatuses of the teaching of the present specification and are not intended to limit the scope of what is taught in any way. In the drawings:

FIG. 1 is a perspective illustration of an injection molding machine;

FIG. 2 is a perspective illustration of a portion of the injection molding machine of FIG. 1;

FIG. 2A is a perspective view of a locking device portion of the structure of FIG. 2;

FIG. 3 is a cross-section taken along line 3-3 in FIG. 1;

FIG. 4 is a cross-section taken along line 4-4 in FIG. 1;

FIG. 4A is a perspective view of an ejector apparatus of the machine of FIG. 1;

FIG. 5 is a front plan view of the injection molding machine of FIG. 1;

FIG. 6 is a rear plan view of the injection molding machine of FIG. 1;

FIG. 7 is a perspective illustration of an injection support portion of the injection molding machine of FIG. 1;

FIG. 8 is a rear perspective illustration of an injection support portion of an injection molding machine according to another embodiment;

FIG. 9 is a front perspective illustration of the injection support portion of the injection molding machine of FIG. 8;

FIG. 10 is a top plan view of the injection support portion of the injection molding machine of FIG. 8; and

FIG. 11 is a top plan view of the injection support portion of the injection molding machine of FIG. 8 with hydraulic and electrical components removed for clarity.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

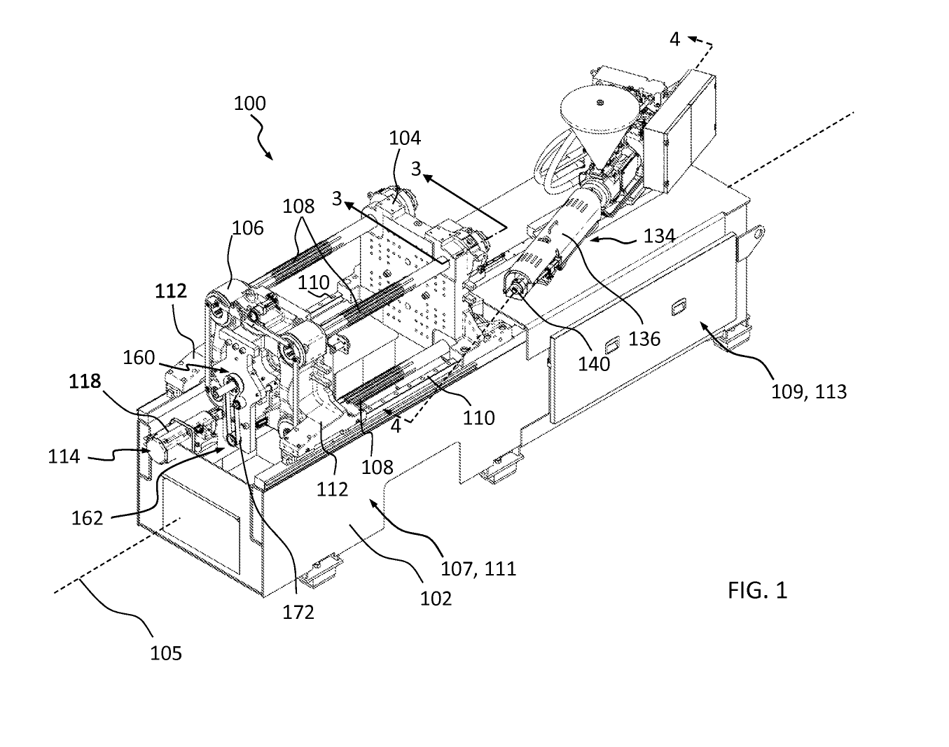

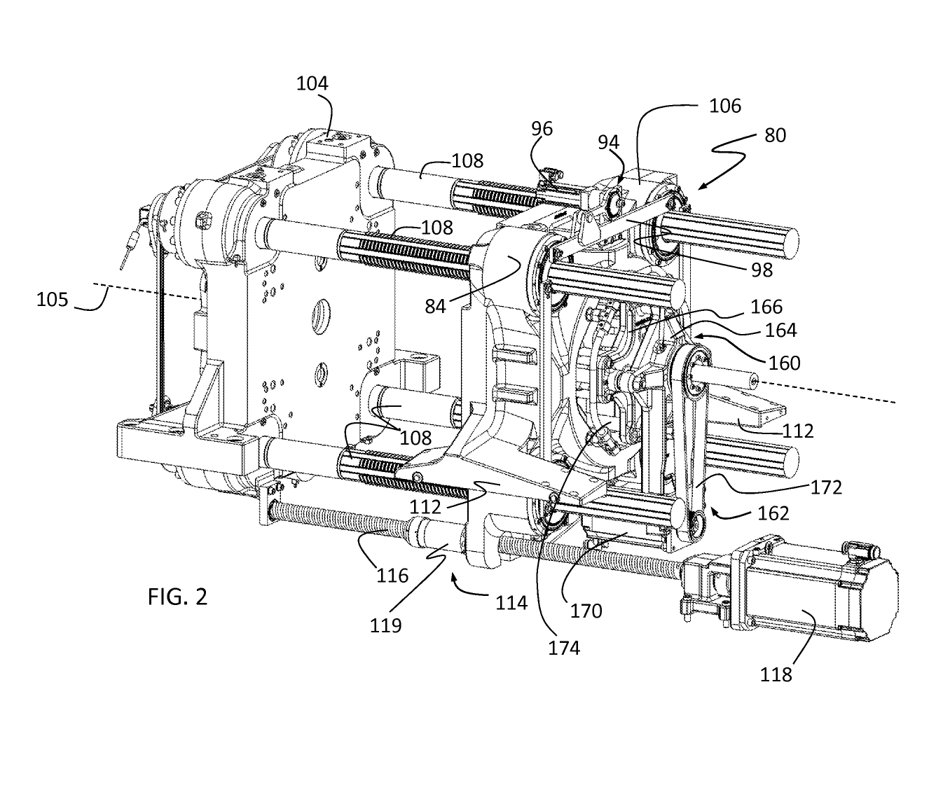

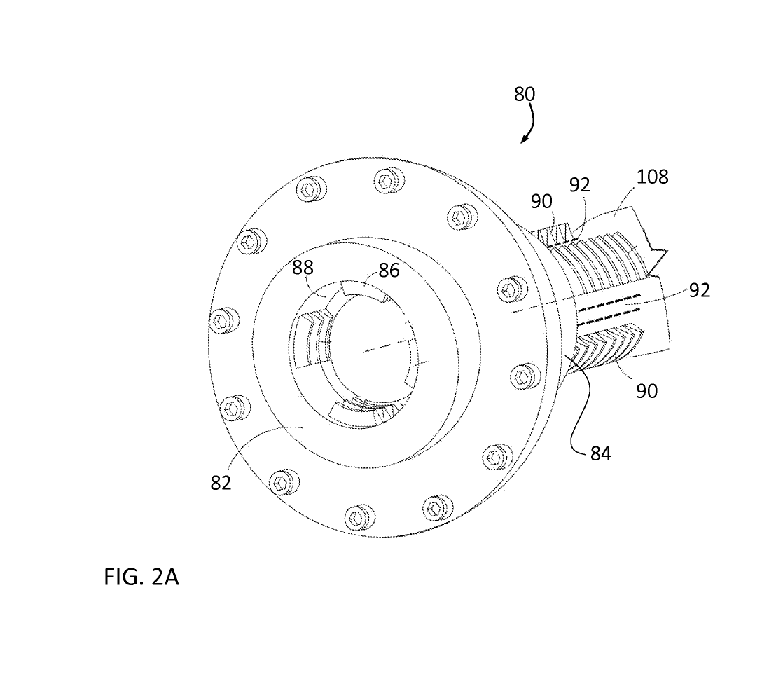

Referring to FIGS. 1 and 2, an exemplary injection molding machine 100 includes a machine base 102 that extends lengthwise along a machine axis 105. A pair of platens, including a stationary platen 104 and a moving platen 106, are supported by the machine base 102 for carrying respective mold halves of a mold. In the example shown, the stationary platen 104 and moving platen 106 are supported by a platen support portion 107 of the machine base 102, which extends along a first axial portion 111 of the base 102. A plurality of tie bars 108 generally extend between the stationary 104 and moving 106 platens. The moving platen 106 can translate towards and away from the stationary platen 104 along a machine axis 105. Each platen 104, 106 supports a respective stationary and moving mold half (not shown) for forming a mold between the platens 104, 106.

The moving platen 106 may be slidably supported on at least one rail of the injection molding machine 100 by at least one runner. In the example shown, the moving platen 106 is slidably supported on a pair of rails 110 by a pair of runners 112, and is movable along the rails 110 between mold-open and mold-closed position. In the example illustrated, as the moving platen 106 moves along the rails 110 between the mold open and closed positions, it moves relative to the machine tie bars 108. In other examples, the tie bars can be fixed to, and moveable with, the moving platen.

Referring to FIG. 2, an electrically driven platen actuator (traverse actuator) 114 is coupled to the moving platen 106 for advancing and retracting the moving platen 106 between mold-closed and mold-open positions. In the example shown, the electrically driven platen actuator 114 includes a first ball screw 116 driven by a first electric motor 118. The ball screw 116 may be fixedly mounted at or near a lower end of the stationary platen 104. The motor 118 may be a solid shaft or hollow shaft motor attached to (and moveable with) the moving platen 106. In the example illustrated, the motor 118 is fixed to the base 102, and a ball nut 119 is fixed to the moving platen and engaged by the ball screw 116. In some examples, an electrically driven belt drive system may be used to move the moving platen 106 between the mold-open and mold-closed positions. In some examples, a plurality of electrically driven ball-screws maybe used to move the moving platen between the mold-open and mold-closed positions.

Referring to FIGS. 2 and 2a, the machine 100 further includes at least one locking device 80 to selectively lock one of the platens 104, 106 to one of the tie bars 108. In the example illustrated, each respective locking device 80 is mounted to the moving platen 106 and associated with a respective one of the tie bars 108. Each respective locking device 80 selectively secures the moving platen 106 and releases the moving platen 106 from, the respective tie bar 108. In some examples, the locking devices may be fixed to the stationary platen 104, and may be integrated with, for example, the clamp actuators described below.

With reference again to FIG. 2a, each locking device 80 can comprise, for example, a lock nut element 82 of generally annular construction rotatably disposed in a lock housing 84 affixed to the moving platen 106. In the example illustrated, the lock nut 82 is provided with an inner bore with first teeth 86 arranged in axial rows, the rows spaced circumferentially apart by first axial grooves 88. Each tie bar 108 can be provided with second teeth 90 that are similarly arranged in axial rows, spaced apart circumferentially by second axial grooves 92.

When in the locked position, the first and second teeth 86, 90 are oriented to be in circumferential registration with each other, so that the first and second teeth inter-engage, thereby inhibiting relative axial motion between the moving platen 106 and tie bar 108. The lock nut 82 can be rotated relative to the tie bar 108 to an unlocked position (FIG. 2a) in which the first teeth 86 are aligned with the second axial grooves 92 provided on the tie bar 108, and the second teeth 90 are aligned with the first axial grooves 88 of the lock nut 82, thereby allowing axial movement of the tie bar 108 through the lock nut 82.

An electrical lock actuator 94 may be provided for moving the locking devices between the locked and unlocked position. In the example illustrated, the lock actuator comprises an electric lock motor 96 coupled to a linkage assembly 98. Energizing the lock motor 96 selectively moves one of the linkage arms (the top, generally horizontal arm in FIG. 2) back and forth in a lateral direction), and by pivot connections to the lock nuts 82 at either end of the arm moves the two upper locking devices between the locked and unlocked positions. Vertical linkage arms at either side of the platen couple the two lower locking nuts 82 for synchronous rotation with the two upper lock nuts 82.

Before moving the locking device 80 from the unlocked to the locked position, the tie bar 108 can be moved axially relative to the lock nut 82 to any one of a plurality of meshing positions in which the peaks of one set of teeth are in axial registration with the valleys between axially adjacent ones of the other set of teeth. Adjacent meshing positions are spaced apart axially by an amount generally equal to the pitch of the teeth. Providing a plurality of meshing positions can facilitate accommodating molds with different axial extents (different mold heights).

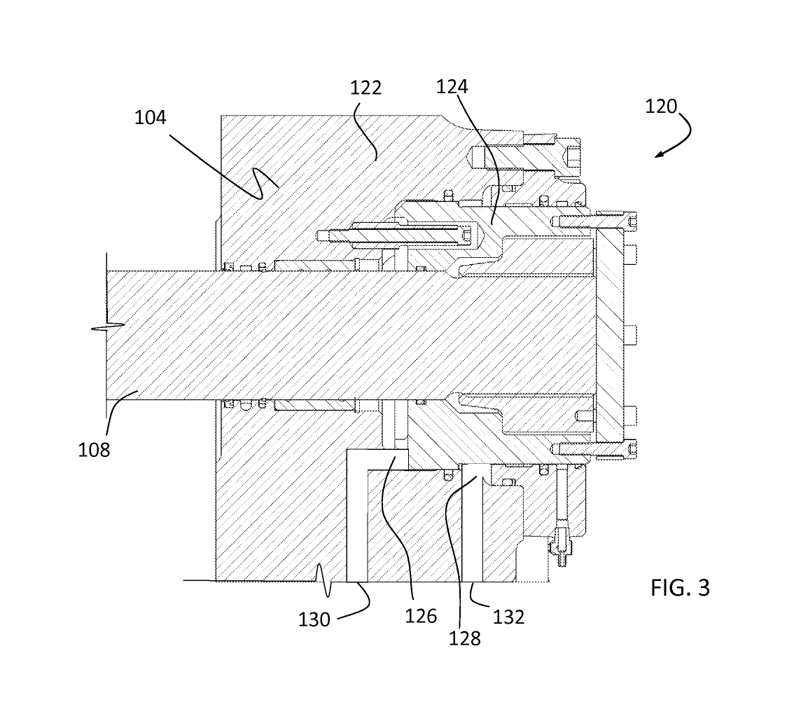

Referring to FIG. 3, at least one hydraulic clamp actuator is coupled to the platens 104, 106 for clamping together the stationary 104 and moving 106 platens when the moving platen 106 is in the mold-closed position. The hydraulic clamp actuator(s) 120 can selectively exert a first force (clamping force) urging the stationary and moving platens 104, 106 together, and an optional second force (mold break force) urging the stationary and moving platens 104, 106 apart. In the example illustrated a first hydraulic clamp actuator 120 is mounted to the stationary platen 104 and associated with one of the tie bars 108. The hydraulic clamp actuator 120 includes a cylinder housing 122 affixed to the stationary platen 104, and a piston 124 affixed to the tie bar 108 and slidable within the cylinder housing 122. The cylinder housing 122 provides a clamp chamber 126 on one side of the piston 124 and an optional unclamp chamber 128 on the opposite side of the piston. Hydraulic fluid can be fed into the clamp and unclamp chambers 126, 128 via a clamping port 130 and unclamp port 132, respectively. In the example illustrated, the clamp and unclamp ports 130, 132 open to an exterior side of the cylinder housing 122. Pressurizing the clamp chamber 126 can exert a force on the piston 124 directed toward the right in FIG. 3, away from the moving platen 106. Pressurizing the unclamp chamber 128 can exert a force on the piston toward the left in FIG. 3, toward the moving platen 106.

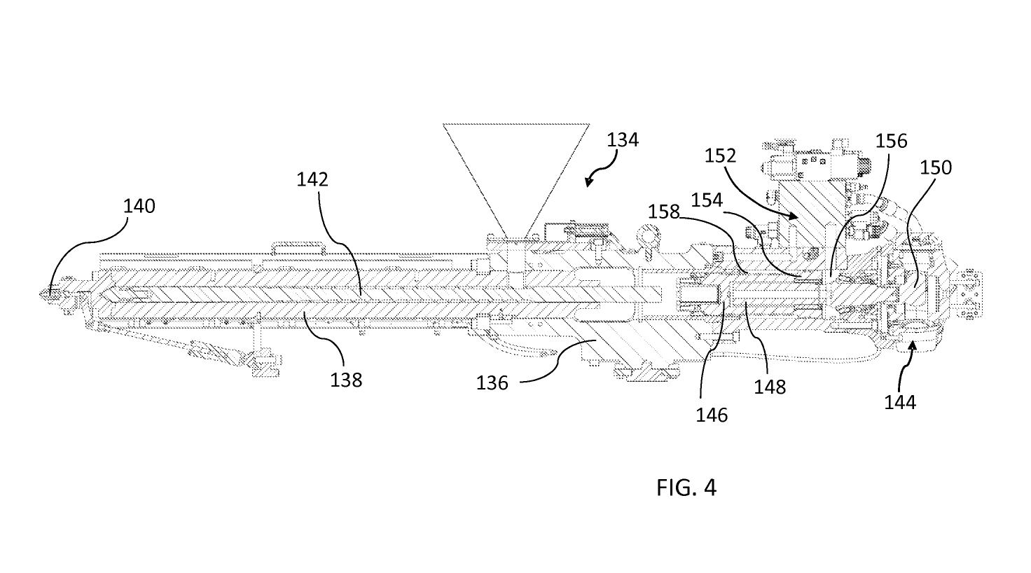

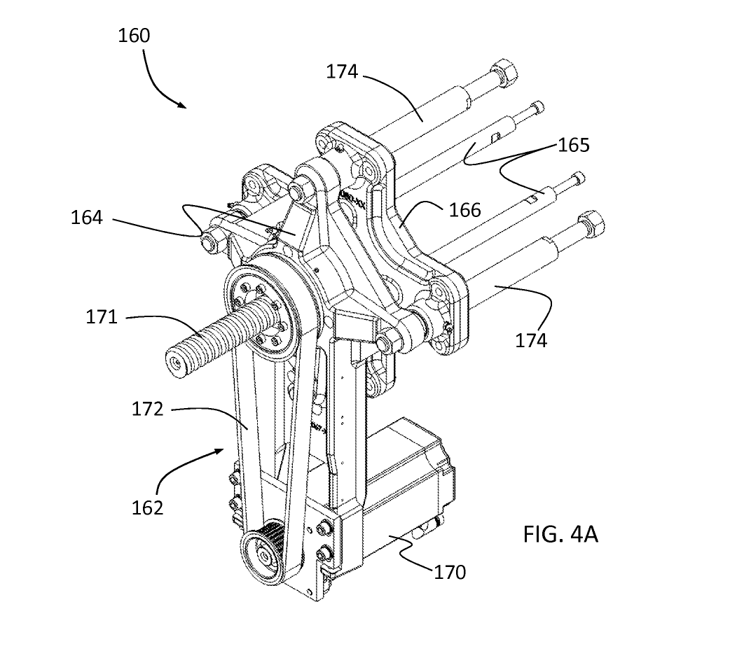

Referring now to FIG. 4, an injection unit 134 is supported by the base 102 for injecting resin or other injection compound (also referred to as melt) into the mold to form a molded article. In the example shown, the injection unit 134 is supported by an injection unit support portion 109 (shown in FIG. 1) of the base, which extends along a second axial portion 113 of the base. The injection unit 134 generally includes a housing 136 and a barrel 138 extending from the housing 136 towards the platens 104, 106. A nozzle 140 is mounted at a front end of the barrel 138. A plasticizing screw 142 is housed within the barrel 138, for plasticizing an injection material. Translation of the plasticizing screw 142 towards an advanced position (towards the left in FIG. 4) forces plasticized injection material through the nozzle 140 and into the mold.

A hydraulically powered rotary injection drive 144 is coupled to the plasticizing screw 142 for rotating the screw 142. In the example shown, the hydraulically powered rotary injection drive 144 includes a hydraulic motor 150 that drives rotation of a rotary spline shaft 148. Rotation of the rotary spline shaft 148 causes a corresponding rotation of a piston 146 that has an inner bore slidably coupled, but rotationally locked, with the outer surface of the spline shaft. A back end of the screw 142 is fixed to the piston, so that rotation of a piston 146 causes a corresponding rotation of the plasticizing screw 142.

A hydraulic injection actuator 152 is coupled to the plasticizing screw 142 for injecting the injection material into the mold. In the example shown, the hydraulic injection actuator comprises the piston 146. The piston 146 includes a piston head 154, and an interior volume of the housing 136 includes a first (advance) pressure chamber 156 on a first side of a piston head 154 and a second (retract) pressure chamber 158 on a second side of the piston head 154. The first pressure chamber 156, when pressurized with hydraulic fluid, urges the piston 146 to slide along the rotary spline shaft 148 towards an advanced position (i.e. towards the nozzle 140). The second pressure chamber 158, when pressurized with hydraulic fluid, urges the piston 146 to slide along the rotary spline shaft 148 towards a retracted position (i.e. away from the nozzle). Sliding of the piston 146 towards the advanced position causes a corresponding sliding of the plasticizing screw 142, which causes injection of the injection material in to the mold.

Referring back to FIG. 2, the injection molding machine 100 further includes an ejector 160. An electrically driven ejector actuator 162 is coupled to the ejector 160 for moving the ejector 160 between advanced and retracted positions for ejecting molded articles from the moving mold-half when the moving platen 106 is in the mold-open position.

Referring also to FIG. 4A, the ejector 160 includes a support plate 164 mounted to the stationary platen 104, and a carrier plate 166 movably mounted to the support plate 164 along the machine axis 105. Ejector pins 165 are attached to the carrier plate 166. When the ejector 160 is in the advanced position, the carrier plate 166 is advanced along the machine axis 105 towards the stationary platen 104. When the ejector 160 is in the retracted position, the carrier plate 166 is retracted along the machine axis 105 away from the stationary platen 104.

In the example shown, the electrically driven ejector actuator 162 includes a second ball screw 171 driven by a second motor 170. The second motor 170 is fixed relative to the moving platen and coupled to the second ball screw by a belt 172. The shaft of the ball screw is fixed to the support plate 164, and a ball nut 173 is fixed to the carrier plate 166. A plurality of rods 174 are mounted between the support plate 164 and the carrier plate 166 to help guide the axial movement of the carrier plate 166 between the advanced and retracted positions. The second motor 170 is, in the example illustrated, mounted to the lower portion of the support plate 164, and is disposed axially forward of the support plate 164 (i.e. extending axially beneath the carrier plate 166 and moving platen 106).

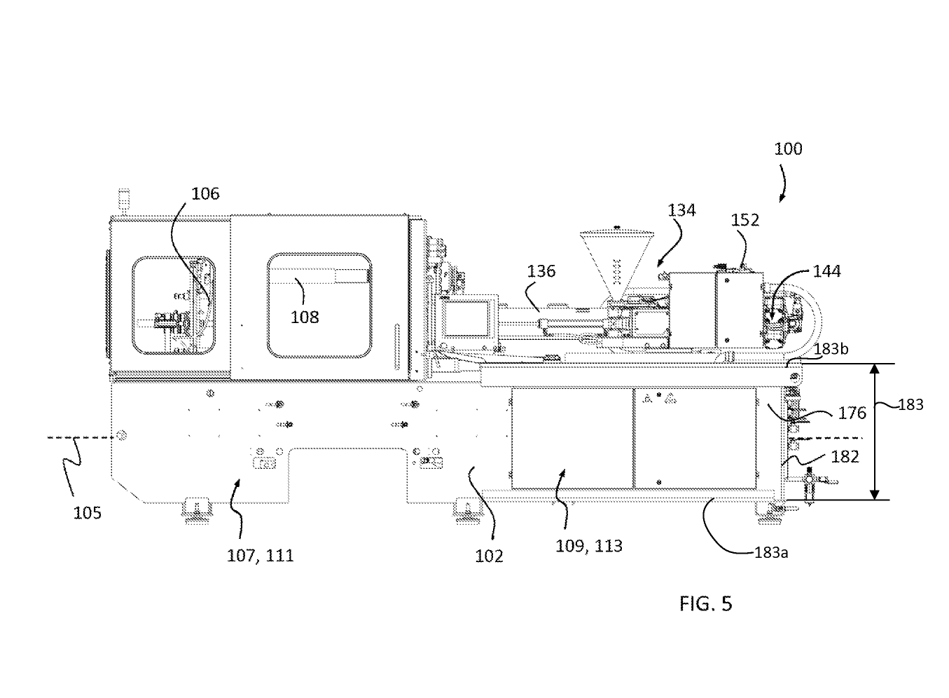

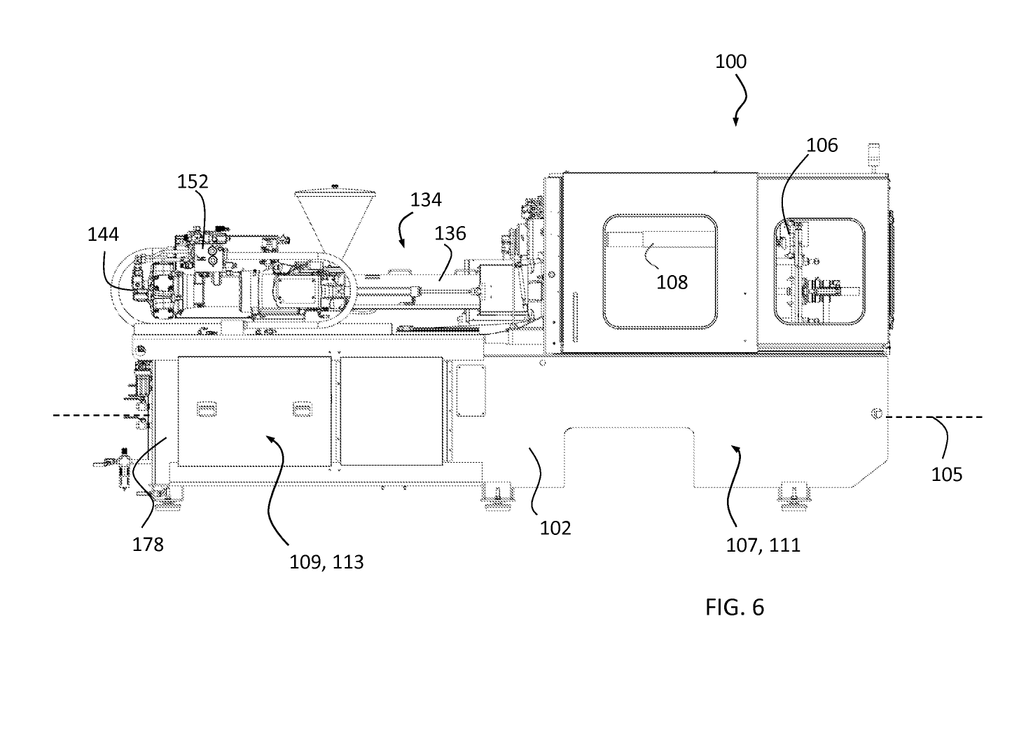

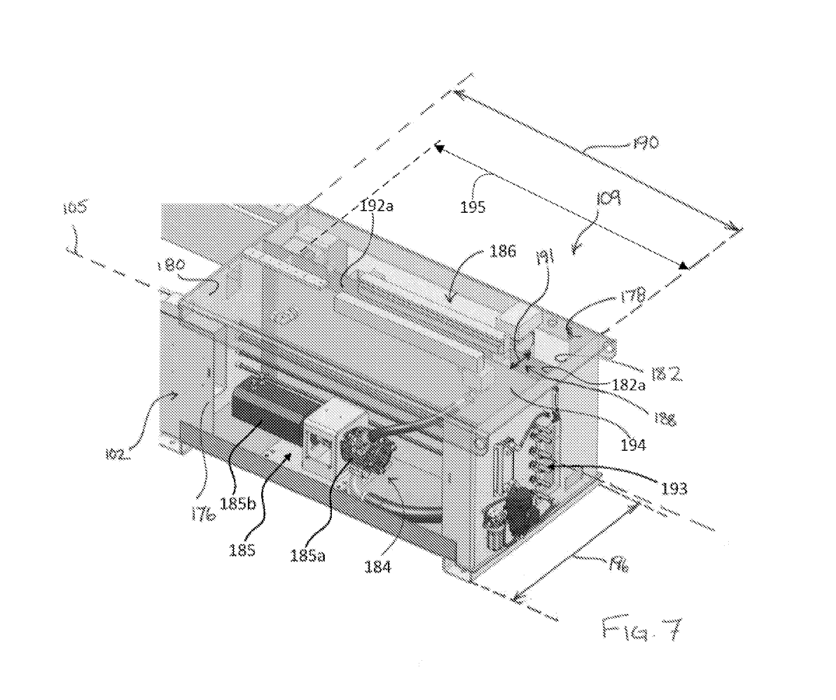

Referring now to FIGS. 5 to 7, in the example shown, the injection unit support portion 109 of the base 102 is generally bounded laterally by an axially extending front wall 176 (shown in FIGS. 5 and 7), and an axially extending back wall 178 (shown in FIGS. 6 and 7). The front wall 176 is at the operator side of the machine 100, and the back wall 178 is at the non-operator side of the machine 100. The injection unit support portion 109 is bounded axially by a laterally extending inner wall 180 (shown in FIG. 7) adjacent the platen support portion 107 and a laterally extending outer wall 182 spaced apart from the inner wall 180. The injection unit support portion 109 has a height 183 that generally extends between a bottom panel 183a and a top panel 183b.

Referring to FIG. 7, the injection unit support portion 109 houses a front cabinet 184, a back cabinet 186, and a hydraulic tank 188. The front cabinet 184 and back cabinet 186 extend, in the example illustrated, generally lengthwise (axially) along the axial extent 190 of the injection unit support portion. At least one vertical support wall 192 is disposed laterally between the front wall 176 and back wall 178, and in the example illustrated, is generally parallel thereto. The support wall 192 can extend the full length of the injection support portion 109, with an inner edge of the support wall 192 attached to the inner wall 180, and an outer edge of the support wall 182 attached to the outer wall 182. The support wall 192 can help to strengthen and reinforce the injection unit support portion 109 of the base 102. The support wall can also serve to help laterally separate the front and back cabinets 184, 186.

In the example illustrated, the hydraulic tank 188 is disposed adjacent the support wall 192. At least a portion of the support wall 192 can provide a first sidewall 192a of the tank 188. This can facilitate positioning the hydraulic tank 188 laterally intermediate the front and back cabinets.

The tank 188 can have a second sidewall 194 generally parallel to, and spaced away from, the first sidewall 192a. The second sidewall 194 can extend lengthwise along the injection unit support portion 109 from an outer end edge proximate the outer end wall 182, to an inner end edge spaced away from the outer wall 182 towards the inner wall 180. The inner end edge of the second sidewall 194 can be proximate to, and/or secured to, the inner wall 180.

Referring still to FIG. 7, in the example shown, the tank 188 has a tank length 195 that extends between an outer tank wall 182a and an inner tank wall 180a. In the example illustrated, the outer tank wall 182a comprises a portion of the end wall 182. The inner tank wall is spaced axially apart from the outer tank wall, and can comprises a portion of the inner end wall 180. Further, the tank 188 has a tank width 191 that extends laterally between the first sidewall 192a of the tank 188 and the second sidewall 194 of the tank 188. The first sidewall 192a is generally parallel to and laterally intermediate the front 176 and back 178 walls of the injection unit support portion 109 of the base 102. The second sidewall 194 is generally parallel to the first sidewall 192a, and, in the example illustrated, is laterally intermediate the first sidewall 192a and the front wall 176 of the injection unit support portion 109. In the example illustrated, the inner tank wall 180a and the second sidewall 194 of the tank 188 each extend the height of the injection support portion 109, and further help to strengthen and reinforce the injection support portion 109 of the base 102.

Referring still to FIG. 7, the base 102 has a base width 196 extending laterally between the front 176 and back walls 178. The base width 196 may be between about 3 times and about 10 times greater than the tank width 191. In the example illustrated, the base width 196 is approximately 7 times greater than the tank width 191. Further, the tank length 195 may be between about 10 and about 20 times greater than the tank width 191. In the example illustrated, the tank length 195 is approximately 14 times greater than the tank width 191.

Referring still to FIG. 7, the front cabinet 184 is laterally disposed generally between the front wall 176 of the base 102 and the second sidewall 194 of the tank 188. The back cabinet 186 is laterally disposed generally between the vertical support wall 192 and the back wall 178 of the base 102.

In the illustrated example, the front cabinet 184 is a pump cabinet and the back cabinet 186 is an electrical cabinet. A pressurized oil delivery system including, for example, a pump unit 185 is housed within the pump cabinet 184. Hydraulic services 193 can be collectively mounted to the outer wall 182 of the base 102. An electrical system is housed within the electrical cabinet, the electrical system including, for example, power supply connections and I/O racks.

Furthermore, in the example illustrated, the platen support portion 107 of the machine generally forms an “electric” side of the machine having electrically driven actuators and drives. The injection unit support portion 109 generally forms a “hydraulic” side of the machine, having hydraulically driven actuators and drives.

In use, the platen actuator 114 can be electrically energized to advance the moving platen 106 towards a closed position relative to the stationary platen 104. In the example illustrated, the moving platen is moved by the platen actuator 114 to a meshing position in which the mold halves supported by the platens may be spaced slightly apart or may be touching each other. When the platen is in the meshing position, the lock nut teeth 86 are axially aligned with, and can be rotated into, the first circumferential valleys between the tie bar teeth 90. In the example illustrated, the lock actuator is electrically energized to move the lock nut 82 to the locked position.

Once the locking devices 80 have been moved to the locked position, the clamp chamber 126 can be pressurized (hydraulically) so as to exert a clamping force urging the mold halves tightly together. The piston 124 would be urged in the clamping direction (i.e. to the right as shown in FIG. 3), stretching the tie bars 108 (within their elastic deformation limit) and pulling the mold halves tightly together. At an appropriate clamping force, the resin (or melt) can be injected into the mold.

In the example illustrated, the hydraulic pump unit 185 comprises a pump 185a driven by a single servo motor 185b for supplying a flow rate of oil from the pump 185a to the hydraulic clamp actuators 120, hydraulic rotary injection drive 144, and hydraulic axial injection actuator 152, in an on-demand, as-needed basis. This configuration can reduce the need for separately controllable servo-valves at each of the hydraulically powered actuators or drives. In some examples, more than one servo-motor and pump may be provided.

After the molded article has hardened sufficiently, the pressure in the clamp chamber 126 can be relieved and the unclamp chamber 128 can be pressurized so as to exert a mold break force urging the mold halves apart and moving the piston 124 to the unclamped position. The locking devices 80 can be moved to the unlocked position so as to unlock the moving platen 106 from the tie bars 108. The platen actuator 114 can then be energized to retract the moving platen 106 to an open position spaced away from the stationary platen 104. The ejector actuator 160 can be energized to facilitate ejection of the molded article from the mold.

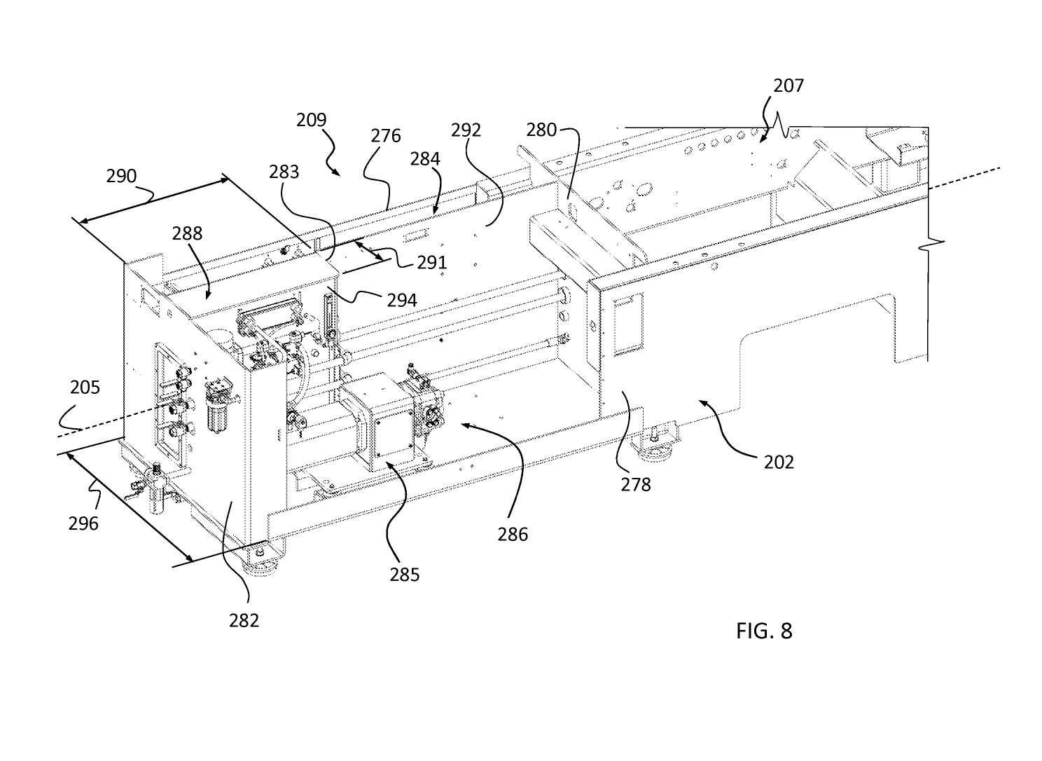

Referring now to FIG. 8, structure of another example of an injection molding machine 200 is illustrated, the machine 200 having similar features as the machine 100, with like features are identified by like reference numerals, incremented by one hundred.

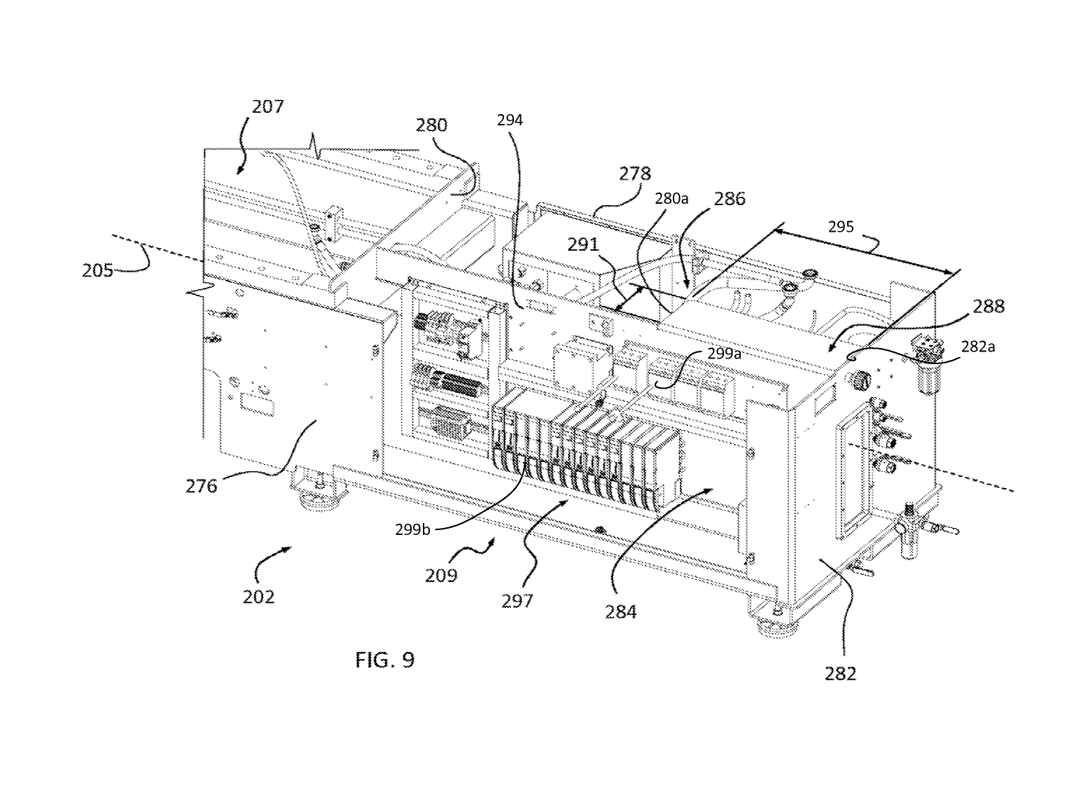

As shown in FIGS. 8 and 9, the machine base 202 extends lengthwise along a machine axis 205 and includes a platen support portion 207 and an injection unit support portion 209. The injection unit support portion 209 is generally bounded laterally by an axially extending front wall 276, and an axially extending back wall 278. The injection unit support portion 209 is further bounded axially by a laterally extending inner wall 280 adjacent the platen support portion 207 and a laterally extending outer wall 282 spaced apart from the inner wall 280.

The injection unit support portion 209 houses a front cabinet 284, a back cabinet 286, and a hydraulic tank 288.

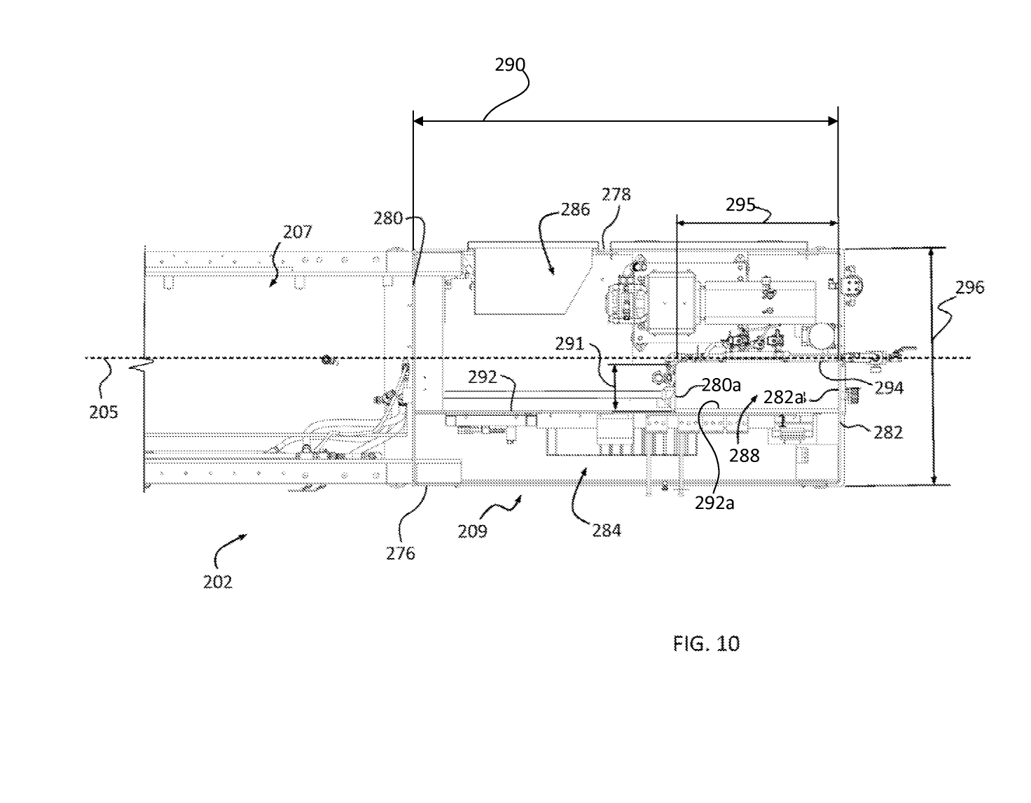

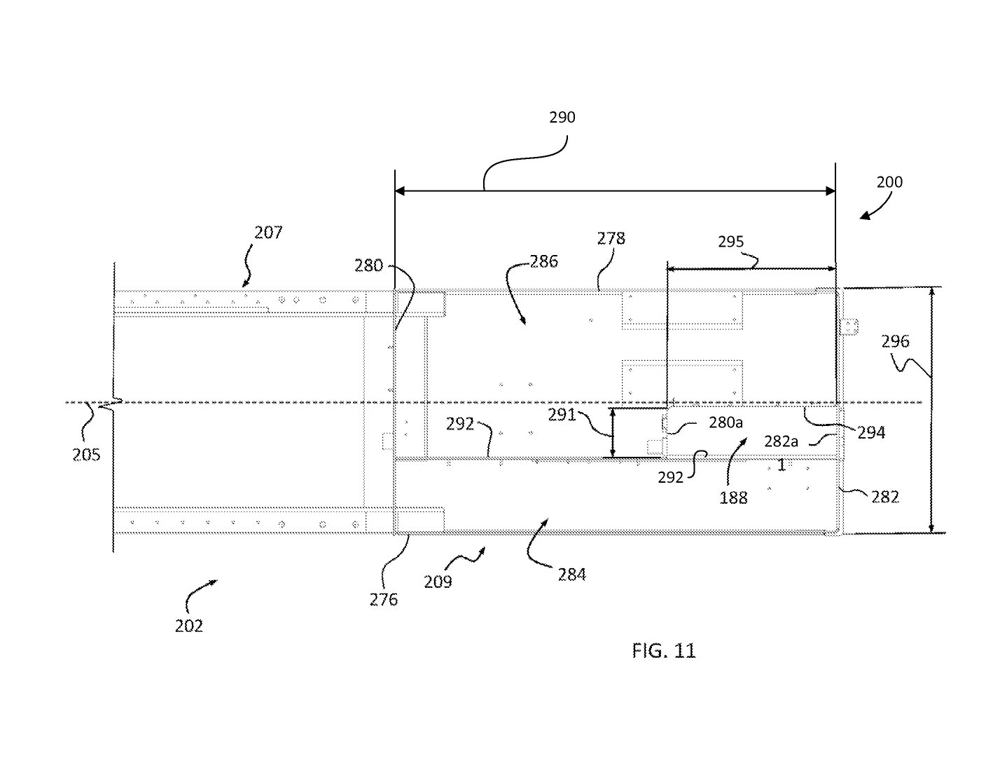

With reference to FIGS. 10 and 11, the tank 288 has a tank length 295 that extends axially between an outer tank wall 282a (which is a portion of the outer end wall 282 in the illustrated example) and a laterally extending inner tank wall 280a. The inner tank wall 280a is generally parallel to the outer wall 282 and is axially intermediate the outer end wall 282 and the inner end wall 280.

The tank 288 also has a tank width 291 that extends laterally between a first sidewall 292a and a second sidewall 294. The first sidewall 292a is generally parallel to and laterally intermediate the front 276 and back 278 walls. The second sidewall 294 is generally parallel to the first sidewall 292a, and in the example illustrated is laterally intermediate the first sidewall 292a and the back wall 278 of the injection unit support portion 209.

In the illustrated example, the vertical support wall 292 extends generally from the outer wall 282 to the inner wall 280, and the second sidewall 294 extends generally from the inner tank wall 281 to the inner tank wall 281. The first sidewall 292a of the tank comprises a portion of the vertical support wall 292.

The base 202 has a base width 296 extending laterally between the front 276 and back walls 278. In the example illustrated, the base width 296 is approximately 5 times greater than the tank width 291. Furthermore, the tank length 290 may be between about 2 and about 10 times greater than the tank width 291. In the example illustrated, the tank length 290 is approximately 4 times greater than the tank width 291.

Referring still to FIGS. 10 and 11, the front cabinet 284 is disposed generally between the front wall 276 of the base 202 and the vertical support wall 292. Further, the back cabinet 286 is disposed generally between the back wall 278 of the base 202 and the second sidewall 294 (along the length thereof) and a portion of the vertical support wall 292 not overlapped by the tank 288. The tank 288 is generally disposed laterally intermediate the front cabinet 284 and the back cabinet 286.

In the illustrated example, the front cabinet 284 is an electrical cabinet and the back cabinet 286 is a pump cabinet. As shown in FIG. 9, an electrical system 297 is housed within the electrical cabinet 284. The electrical system 297 can include, for example, power supply connections 299a and I/O racks 299b. A portion or all of the components of the electrical system 297 may be mounted directly to the vertical support wall 292. As shown in FIG. 8, a pressurized oil delivery system including, for example, a pump unit 285 is housed within the pump cabinet 286. The configuration of the pump cabinet, tank, and electrical cabinet as taught herein can help to simplify the routing of wiring and electrical and hydraulic components of the machine. This can help to reduce manufacturing costs and maintenance costs.

While the above description provides examples of one or more processes or apparatuses, it will be appreciated that other processes or apparatuses may be within the scope of the accompanying claims.

1. An injection molding machine, comprising:
a) a machine base;
b) a stationary platen and a moving platen supported by the machine base, each platen supporting a respective stationary and moving mold half for forming a mold between the platens;
c) a plurality of electrically powered machine components, including:
(i) an electrically driven platen actuator coupled to the moving platen for advancing and retracting the moving platen between mold-closed and mold-open positions; and
(ii) an ejector coupled to the moving platen and actuated by an electrically driven ejector actuator coupled to the ejector for moving the ejector between advanced and retracted positions for ejecting molded articles from the moving mold half when the moving platen is in the mold-open position; and
d) a plurality of hydraulically powered machine components, including:
(i) at least one hydraulic clamp actuator coupled to the platens for clamping together the stationary and moving platens when the moving platen is in the mold-closed position; and
(ii) an injection unit supported by the machine base including a plasticizing screw for plasticizing an injection material and a hydraulically powered rotary injection drive coupled to the plasticizing screw for rotating the plasticizing screw, and a hydraulic injection actuator coupled to the plasticizing screw for injecting the injection material into the mold.

2. The injection molding machine of claim 1, further comprising a plurality of tie bars generally extending between the stationary and moving platens, wherein each of the at least one hydraulic clamp actuators comprises a piston affixed to a respective tie bar and slidable within a respective cylinder housing, each cylinder housing providing a clamp chamber and an unclamp chamber on opposite sides of the respective piston.

3. The injection molding machine of claim 2, wherein the plurality of electrically powered machine components further comprises a locking device mounted to one of the platens, the locking device moveable between a locked position in which axial movement of the moving platen relative to the tie bars is restricted and an unlocked position in which axial movement of the moving platen relative to the tie bars is unrestricted, the locking device actuated by an electrically driven locking device actuator for moving the locking device between the locked and unlocked positions.

4. The injection molding machine of claim 3, wherein the platen actuator comprises a first ball screw driven by a first motor.

5. The injection molding machine of claim 4, wherein the ejector actuator comprises a second ball screw driven by a second motor.

6. The injection molding machine of claim 1, wherein the machine base comprises an injection unit support portion beneath the injection unit and a platen support portion beneath the platens.

7. The injection molding machine of claim 6, wherein the injection unit support portion of the base houses an electrical cabinet, a pump cabinet, and a hydraulic tank disposed laterally intermediate the pump cabinet and the electrical cabinet.

8. The injection molding machine of claim 7, wherein the injection unit support portion of the base has an axial length extending between an inner end wall adjacent the platen support portion and an outer end wall spaced apart from the inner end wall, and a vertical support wall having opposed inner and outer ends attached to the inner and outer end walls, respectively, wherein at least a portion of the vertical support wall forms a first sidewall of the hydraulic tank.

9. The injection molding machine of claim 8, further comprising an electrical system inside the electrical cabinet, wherein each one of the electrically powered machine components is in electrical communication with the electrical system inside the electrical cabinet.

10. The injection molding machine of claim 8, further comprising a pressurized oil delivery system inside the pump cabinet, the pressurized oil delivery system drawing oil from the hydraulic tank, and wherein each one of the hydraulically powered machine components is in fluid communication with the pressurized oil delivery system inside the pump cabinet.

11. An injection molding machine, comprising:
a) a base extending lengthwise along a machine axis, the base having a platen support portion extending along a first axial portion of the base, and an injection unit support portion extending along a second axial portion of the base;
b) a pair of platens supported by the platen support portion of the base for carrying respective mold halves of a mold; and
c) an injection unit supported by the injection unit support portion of the base for injecting melt into the mold;
wherein the injection unit support portion of the base houses an electrical cabinet, a pump cabinet, and a vertical support wall disposed laterally intermediate the pump cabinet and the electrical cabinet and extending lengthwise of the injection unit support portion, the injection unit support portion of the base further housing a hydraulic tank, at least a portion of the vertical support wall providing a first sidewall of the hydraulic tank.

12. The injection molding machine of claim 11, wherein the injection unit support portion is generally bounded laterally by an axially extending front wall and an axially extending back wall, and the injection unit support portion is generally bounded axially by a laterally extending inner wall adjacent the platen support portion, and a laterally extending outer wall spaced apart from the inner wall, and wherein the vertical support wall has a support wall length that extends from an inner edge joined to the inner wall to an outer edge joined to the outer wall of the injection unit support portion of the base.

13. The injection molding machine of claim 12, wherein the hydraulic tank has a tank width that extends laterally between the first sidewall and a second sidewall, the first sidewall generally parallel to, and laterally intermediate, the front and back walls of the injection unit support portion of the base, and the second sidewall generally parallel to the first sidewall, and laterally intermediate the first sidewall and the back wall of the injection unit support portion.

14. The injection molding machine of claim 13, wherein the pump cabinet is disposed in the injection unit support portion of the machine base, generally between the front wall and the first sidewall, and the electrical cabinet is disposed in the injection unit support portion of the machine base, generally between the second sidewall and the back wall.

15. The injection molding machine of claim 13, wherein the electrical cabinet is disposed in the injection unit support portion of the machine base, generally between the front wall and the first sidewall, and the pump cabinet is disposed in the injection unit support portion of the machine base, generally between the second sidewall and the back wall.

16. The injection molding machine of claim 13, wherein the base has a base width extending laterally between the front and back walls, and the base width is between about 3 times and about 10 times greater than the tank width.

17. The injection molding machine of claim 16, wherein the tank length is between about 2 times and about 20 times greater than the tank width.

18. The injection molding machine of claim 11, further comprising a plurality of electrically powered machine components, wherein each one of the electrically powered machine components is in electrical communication with an electrical system housed in the electrical cabinet.

19. The injection molding machine of claim 18, further comprising a plurality of hydraulically powered machine components, wherein each one of the plurality of hydraulically powered machine components is in fluid communication with a pressurized oil delivery system housed in the pump cabinet.
